(19) United States
(12) Patent Application Publication
(10) Pub. No.: US 2004/0194389 A1
(43) Pub. Date: Oct. 7, 2004

(54) Pneumatic power window

(76) Inventor: Antonio Ardavin, Miami, FL (US)

Correspondence Address: ANTONIO ARDAVIN, 7323 SW 132 PL, MIAMI, FL, 33183, US

(21) Appl. No.: 10/405,790

(22) Filed: Apr. 1, 2003

(51) Int. Cl. E05F 15/08

(52) U.S. Cl. 49/349

(57) ABSTRACT

An electric 12-volt air compressor provides the energy for the Pneumatic Power Window's working pressure.

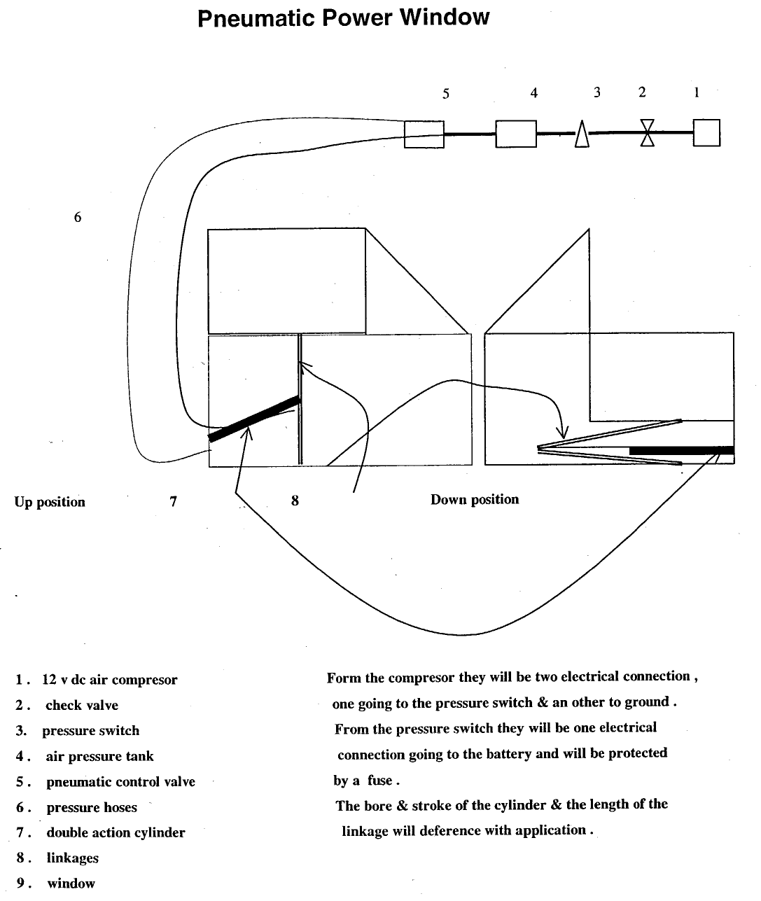

A normally close pressure switch controls working pressure by stopping and stating the compressor at the preset setting.

Before the pressure switch there is a check valve that prevent air pressure from leaking through the compressor.

An air pressure tank provide the volume of air, and a pneumatic manual 3/5 control valve for a double action cylinder is used to control the action of one window.

A hinged linkage is connected to the rod of the cylinder & the other end of the cylinder is connected to the frame of the door.

The hinged linkage is connected to the center bottom of the window & the other end is connected the bottom center inside frame of the door.

The Pneumatic Power Window is a device that replaces an electric power window used in the automotive industry.

The function is a lot simpler, I think is less expensive & safer that the electric widow in used today.

The components are available at many wholesales pneumatic supply businesses & the prices are reasonable.

The Pneumatic Power Window could be used in new cars or retrofit in used cars equiped with electric window or mechanical.

### BACKGROUND OF THE INVENTION

Some time in 1970's I witness a car going in the Miami River because the weather was bad, the car went into a boat ramp and all I saw was his tail light because it was raining so much, visibility was no more than 10 ft., I pulled off the road were I was familiar with the area, the car that went in the water had New Jersey plates and to me & the police gave the impression that the person did not know the area. The person in the car drowned because his electric widows did not work under water.

My first car with electric windows was a 1985 Corvette and there was no way I could get mechanical window in that car.

Recently there was a story on the news that a lady drove her car in a 12 ft deep canal and people went in the water to help and they were not able to help and the lady drowned and that was coutght on camera. The car was equipped with electric window and they did not work under water.

My Pneumatic Power Window will open a window under water because water does not have any affect on air pressure like it has on electricity.

### BRIEF SUMMARY OF THE INVENTION

The Pneumatic Power Window is a simple pneumatic system that instead of an electric motor uses a pneumatic double action cylinder to work the windows of a vehicle up & down.

The advantages of THE PNEUMATIC POWER WINDOW is that if a vehicle goes in a body of water the windows will open so that the occupants can escape to the surface & live.

This is a safety subject that as far as I know, has never being address by any of the automakers and has always concerned me because of my experiences.

### DETAILED DESCRIPTION

An electric 12-volt air compressor provides the energy for the Pneumatic Power Window, working pressure is controlled by a pressure switch, before the pressure switch there is a check valve from prevent air pressure to leak through the compressor.

An air pressure tank provide the volume of air, a pneumatic control valve for a double action cylinder is used to control the action of one window, a hinge linkage of equal size is connected to the rod of the cylinder & the other end of the cylinder is connected to the frame of the door.

The hinge linkage is connected to the center bottom of the window & the other end is connected the bottom center inside frame of the door.

All components are available, is just a process of assembling the hoses & connecting them to the differant components.

What I claim as my invention is: THE PNEUMATIC POWER WINDOW.

1. Simple in design

2. Practical & efficient

3. Economical & the components are readily available

4. If a vehicle goes in a body of water an is equipped with a Pneumatic Power Window the windows will open allowing the occupancies to escape to the surface.

5. The on board supply of air pressure could be used to inflate tires in the event of a flat or any other sport related item like basketball, football, beach ball or a raft for the beach.
